(19) United States
(12) Patent Application Publication
(10) Pub. No.: US 2006/0243171 A1
(43) Pub. Date: Nov. 2, 2006

(54) Wet gypsum accelerator and methods, composition, and product relating thereto

(75) Inventors: Qiang Yu, Grayslake, IL (US); Stewart Hinshaw, Pearland, TX (US); Michael M. Streeter, Deer Park, TX (US); W. David Song, Gurnee, IL (US); Michael Bolind, Ingleside, IL (US); Robert Price, Crosby, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: United States Gypsum Company, Chicago, IL (US)

(21) Appl. No.: 11/116,550

(22) Filed: Apr. 27, 2005

(51) Int. Cl. C04B 28/14; C04B 11/00

(52) U.S. Cl. 106/778; 106/781; 106/783

(57) ABSTRACT

A wet gypsum accelerator comprising ground product having a median particle size of from about 0.5 micron to about 2 microns and calcium sulfate dihydrate, water, and at least one additive selected from the group consisting of (i) an organic phosphonic compound, (ii) a phosphate-containing compound, or (iii) a mixture of (i) and (ii), is disclosed. Also disclosed are a method of preparing a wet gypsum accelerator, a method of hydrating calcined gypsum to form an interlocking matrix of set gypsum, a set gypsum-containing composition, and a set gypsum-containing product.

### TECHNICAL FIELD OF THE INVENTION

The present invention relates generally to gypsum compositions. More particularly, the invention relates to wet gypsum accelerators for accelerating the hydration of calcined gypsum to calcium sulfate dihydrate, as well as to methods, compositions, and products related thereto.

### BACKGROUND OF THE INVENTION

Set gypsum, which comprises calcium sulfate dihydrate, is a well-known material that is included commonly in many types of products. By way of example, set gypsum is a major component of end products created by the use of traditional plasters, for example, plaster-surfaced internal building walls, and also of gypsum boards employed in typical drywall construction of interior walls and ceilings of buildings. In addition, set gypsum is the major component of gypsum/cellulose fiber composite boards and products, and also is included in products that fill and smooth the joints between edges of gypsum boards.

Typically, such gypsum-containing products are prepared by forming a mixture of calcined gypsum, that is, calcium sulfate hemihydrate and/or calcium sulfate anhydrite, and water, as well as other components, as desired. The mixture typically is cast into a pre-determined shape or onto the surface of a substrate. The calcined gypsum reacts with water to form a matrix of crystalline hydrated gypsum or calcium sulfate dihydrate. It is the desired hydration of the calcined gypsum that enables the formation of an interlocking matrix of set gypsum, thereby imparting strength to the gypsum structure in the gypsum-containing product. In general, the hydration rate and percent conversion rate could impact the final strength and production speed of the gypsum-containing product. Mild heating can be used to drive off unreacted water to yield a dry product.

Regardless of the type of gypsum-containing product being made, accelerator materials commonly are included in the mixture comprising calcined gypsum and water in order to enhance the efficiency of hydration, to control set time, and to maximize production speed. Typically, the accelerator material includes finely ground dry calcium sulfate dihydrate, commonly referred to as “gypsum seeds.” The gypsum seeds enhance nucleation of the set gypsum crystals, thereby increasing the crystallization rate. As is known in the art, conventional gypsum seed accelerator materials progressively lose their effectiveness upon aging, even under normal conditions. In this respect, some efficiency of the accelerator is lost even during grinding, and the gypsum seeds lose potency over time during handling or storage. The loss of acceleration efficiency of conventional accelerator materials is exacerbated when the accelerator is exposed to heat and/or moisture.

To combat the loss of efficiency of the gypsum seeds over time, particularly under conditions of heat and/or moisture, it is customary to coat the calcium sulfate dihydrate accelerator material with any of a number of known coating agents, such as, for example, sugars, including sucrose, dextrose and the like, starch, boric acid, or long chain fatty acids, and salts thereof. Conventional heat resistant accelerator materials are both ground and provided in dry form inasmuch as accelerator loses efficiency upon contact with moisture, for example, because the accelerator particles undesirably agglomerate and/or because both the gypsum and coating agents often are hydroscopic in nature and as such attract moisture.

A wet gypsum accelerator was disclosed in commonly assigned U.S. Pat. No. 6,409,825. However, there remains a need for a wet gypsum accelerator with superior properties as well as new techniques and systems for producing such an accelerator.

### BRIEF SUMMARY OF THE INVENTION

The present invention provides a wet gypsum accelerator, a method of preparing a wet gypsum accelerator, a method of hydrating calcined gypsum to form an interlocking matrix of set gypsum, a set gypsum-containing composition, and a set gypsum-containing product.

The wet gypsum accelerator of the invention comprises ground product having a median particle size of from about 0.5 micron to about 2 microns, wherein the ground product comprises calcium sulfate dihydrate. The wet gypsum accelerator further comprises water, and at least one additive selected from (i) an organic phosphonic compound, and (ii) a phosphate-containing compound. Mixtures of (i) and (ii) can also be used. The wet gypsum accelerator is prepared via wet grinding. Water, the additive, and gypsum are combined in any order to form a mixture, with other optional components added, as desired. When combined with the water, the gypsum can be in the form of calcium sulfate dihydrate, or alternatively, at least some of the gypsum can be in the form of calcined gypsum, that is, calcium sulfate hemihydrate and/or calcium sulfate anhydrite. The calcined gypsum is converted at least in part to calcium sulfate dihydrate in the presence of the water. Excess water in the wet gypsum grinding is desirable to facilitate grinding. Preferably, the gypsum is in the form of calcium sulfate dihydrate when grinding is initiated, but grinding can begin before all of the calcined gypsum is converted to calcium sulfate dihydrate. The calcium sulfate dihydrate is wet ground in the presence of the additive(s) to form the wet gypsum accelerator.

The wet gypsum accelerator according to the invention is useful for the preparation of a set gypsum-containing composition, and for a product comprising the set gypsum-containing composition. In particular, the wet gypsum accelerator of the invention can be combined with water and calcined gypsum in any order to form an aqueous mixture in which the calcined gypsum is hydrated to form an interlocking matrix of set gypsum. Preferably the calcined gypsum is first mixed with water and then mixed with the wet gypsum accelerator.

In accordance with the present invention, the wet gypsum accelerator comprises a ground product. The ground product comprises calcium sulfate dihydrate. The ground product has a median particle size of from about 0.5 micron to about 2 microns. It has been found that the wet gypsum accelerator described improves the efficiency in making set gypsum-containing compositions and products by increasing the rate of hydration of the calcined gypsum to form the interlocking matrix of set gypsum, which may be measured by the time to 50% hydration. The invention is useful in the manufacture of any of a variety of set gypsum-containing products formed from calcined gypsum, such as, but not limited to, ceiling materials, board such as wallboard, plaster, joint compounds, flooring materials, specialty materials, and the like.

The wet gypsum accelerator of the invention can be used in the preparation of set gypsum products prepared by any of the variety of processes known in the art by adding the wet gypsum accelerator to an aqueous calcined gypsum mixture. One suitable method for introducing the wet gypsum accelerator to the aqueous gypsum mixture is described in concurrently filed and co-owned application “METHODS OF AND SYSTEMS FOR ADDING A HIGH VISCOSITY GYPSUM ADDITIVE TO A POST-MIXER AQUEOUS DISPERSION OF CALCINED GYPSUM” (Attorney Reference No. 234910), U.S. patent application Ser. No. ______.

Advantageously, the wet gypsum accelerator of the invention exhibits substantial longevity and maintains its effectiveness over time such that the wet gypsum accelerator can be made, stored, and even transported over long distances, prior to use. Due to its special nature, the wet gypsum accelerator is considered to be a high heat and/or moisture resistant material such that it maintains all or most of its effectiveness even upon exposure thereto. In preferred embodiments, the invention also reduces manufacturing costs because the additives preferably are provided in relatively small amounts and the water to stucco ratio of the stucco slurry is reduced when wet gypsum accelerator is used as compared to dry gypsum accelerator. The invention reduces manufacturing expense further when a second accelerator material, such as potash or aluminum sulfate, generally is not required because the wet gypsum accelerator maintains its high efficiency over time and upon exposure to high humidity. Nevertheless, second accelerator materials can be utilized if desired. The invention also facilitates ease and efficiency of manufacture by permitting wet mixing of the accelerator with calcined gypsum and other components used in making certain set gypsum-containing products, such as, but not limited to, gypsum-cellulosic fiber wallboard.

The wet gypsum accelerator for gypsum board production and fiber panel production is useful for improving stucco hydration rate, improving stucco effectiveness, and reducing manufacturing costs. Stucco effectiveness can be measured by rate of conversion.

These and other advantages of the present invention, as well as additional inventive features, will be apparent from the description of the invention. The invention may best be understood with reference to the following detailed description of the preferred embodiments.

### DETAILED DESCRIPTION OF THE INVENTION

The present invention provides a wet gypsum accelerator comprising a ground product. The ground product is the result of wet grinding of a calcium sulfate substance in the presence of various additives. Such additive comprise an additive selected from an organic phosphonic compound; a phosphate-containing compound; and a mixture of an organic phosphonic compound and a phosphate-containing compound. The ground product has a median particle size of from about 0.5 micron to about 2 microns and comprises at least calcium dihydrate and water, and may further comprise one or more of additive compound including during grinding. More than one of each type of additive can be used in the practice of the invention. The ground product's median particle size range is believed to be responsible for a wet gypsum slurry that has the necessary workability to be utilized in a continuous or batch production process without a sacrificed acceleration efficiency of the stucco hydration.

The inventive wet gypsum accelerator is preferably prepared by wet grinding calcium sulfate dihydrate in the presence of additive under conditions sufficient to produce a ground product with a median particle size of from about 0.5 micron to about 2 microns. Once prepared, the wet gypsum accelerator of the invention is useful for enhancing efficiency in the manufacture of a set gypsum-containing product. Wet gypsum accelerator is combined with calcined gypsum and water, as well as other components as desired, to form a mixture that is cast into a pre-determined shape or onto a substrate surface, during manufacture of the set gypsum-containing product. As is well understood in the gypsum art, calcined gypsum is hydrated in the presence of water to form crystalline hydrated gypsum. When there is a sufficient amount of calcined gypsum that is hydrated, an interlocking matrix of set gypsum typically forms.

Inclusion of the wet gypsum accelerator of the invention in the mixture of calcined gypsum and water enhances the rate of, and predictability in the time required for, the hydration of calcined gypsum to the calcium sulfate dihydrate of the desired set gypsum-containing product. It is believed that the wet gypsum accelerator of the invention provides nucleation sites by increasing the rate of crystallization of the resulting interlocking matrix of set gypsum. The wet gypsum accelerator of the invention can be used in making any of a variety of set gypsum-containing products, such as, for example, conventional gypsum board or gypsum-cellulosic fiber board such as FIBEROCK® composite panels, commercially available from USG Corporation, as well as ceiling materials, flooring materials, joint compounds, plasters, specialty products, and the like.

The wet gypsum accelerator according to the invention exhibits substantial longevity such that it maintains all or most of its effectiveness over long periods of time. Preferably, the wet gypsum accelerator of the invention maintains all or most of its effectiveness for at least several weeks, and more preferably, for at least a few months, for example, three months, and still more preferably, for at least six months, or even longer. As a result, the wet gypsum accelerator can be prepared and then stored and/or transported, even over long distances, prior to use. The wet gypsum accelerator of the invention preferably remains effective even upon exposure to elevated temperatures and/or humidity. Also, because the inventive wet gypsum accelerator maintains its efficiency over time, even upon exposure to high humidity, a second accelerator material, such as potash or aluminum sulfate, is not required in the practice of the invention, although the second accelerator material can be included for certain applications and practices if desired. The wet gypsum accelerator according to the invention can be used in making set gypsum-containing products prepared by either a dry or wet feed system. For example, a dry feed system for producing gypsum board, and a wet feed process for making gypsum-cellulosic fiber composite boards. In some embodiments, although wet gypsum accelerator is produced in the presence of water, once produced the accelerator can be dried.

The wet gypsum accelerator according to the invention is prepared by wet grinding. The gypsum feed material utilized in the grinding process can have any suitable initial median particle size. In some embodiments, the gypsum feed material has an initial median particle size of 50 microns or greater. In some embodiments, the gypsum feed material is natural gypsum and has an initial median particle size of about 20 to about 30 microns. In some embodiments, the gypsum feed material is synthetic gypsum and has an initial median particle size of about 40 to about 100 microns. In accordance with the invention, gypsum, water, and at least one additive are combined to form a mixture. In some embodiments, gypsum used to form the mixture for wet grinding is calcium sulfate dihydrate. In other embodiments, the gypsum can be in the form of calcined gypsum when it is combined with water. If calcined gypsum, the calcined gypsum is believed to be hydrated by a portion of the water to form calcium sulfate dihydrate. Preferably, the gypsum is in the form of calcium sulfate dihydrate when wet grinding commences, but all of the calcined gypsum need not be converted to calcium sulfate dihydrate at this point. A sufficient amount of water beyond that which is required to hydrate the calcined gypsum preferably is included in the mixture to accommodate the wet grinding step after the calcium sulfate dihydrate is formed. In such cases, the additive preferably is added after most, and more preferably, all of the calcium sulfate dihydrate is formed so as to maximize the exposure of the additive to the calcium sulfate dihydrate.

The calcium sulfate dihydrate, as combined with the water or after it is formed in the water from calcined gypsum, is wet ground in the presence of the additive component to form the wet gypsum accelerator. Generally, the smaller the median particle size of the resulting ground product, the better the acceleration efficiency for making set gypsum-containing compositions and products. However, as the median particle size decreases, the viscosity of the wet gypsum accelerator slurry increases such that the slurry becomes increasingly difficult to handle and process. The high viscosity slurry can be diluted after grinding, or in subsequent grinding passes, with additional water or aqueous solution to make it easier to handle and process. Thus, the particle size of the calcium sulfate dihydrate can be as small as desired to allow for the efficient production of set gypsum. In some embodiments where an additional dilution step is not performed, a sufficiently large particle size may be employed to allow for the production of a wet gypsum accelerator slurry with a viscosity sufficiently low to allow slurry pumps and other processing machinery to effectively handle the slurry during the milling and set gypsum forming processes. In other embodiments, a small particle size is maintained, and the slurry is diluted before use.

The mixture comprising calcium sulfate dihydrate, water, and additive is milled preferably under conditions sufficient to provide a slurry in which the ground product has a median particle size of from about 0.5 micron to about 2 microns. Preferably, the ground product has a median particle size of from about 1 micron to about 1.7 microns. More preferably, the ground product has a median particle size of from about 1 micron to about 1.5 microns. Desirably, the standard deviation of the particle size distribution for the calcium sulfate dihydrate particles is less than 5 microns. Preferably, the standard deviation is less than 3 microns. Particle size of wet gypsum accelerator can be measured using laser scattering analysis and/or other appropriate technique. Suitable laser scattering instruments are available from Horiba, Microtrack, and Malvern. A Horiba instrument was employed for the measurements described in the examples section.

Alternatively, the mixture comprising calcium sulfate dihydrate, water, and additive desirably is milled under conditions sufficient to provide a slurry having a viscosity in the range of about 1000 cP or greater at a temperature ranging from room temperature to about 150° F. Typically, the wet gypsum accelerator has a viscosity in the range of from about 1000 cP to about 5000 cP. Preferably, the wet gypsum accelerator has a viscosity in the range of from about 2000 cP to about 4000 cP. More preferably, the wet gypsum accelerator has a viscosity in the range of from about 2500 cP to about 3500 cP. In some embodiments, the viscosity range is about 2800 cP to about 3200 cP). The above viscosity ranges are ranges measured in the absence of dispersants or other chemical additives that would have a significant effect on viscosity or the measurement thereof.

The ground product of the milling process have been found to be substantially irregularly shaped and amorphous. Calcium sulfate dihydrate formed by conventional wet milling processes typically are highly crystalline. Wet milling in the presence of an additive antagonizes the recrystallization to form defined crystalline gypsum particles. Accordingly, the ground product is substantially amorphous meaning that the ground product comprises little or no defined crystal shape. Typically, about 60% or more of the ground product is amorphous. Preferably, about 75% or more of the ground product is amorphous. More preferably, about 90% or more of the ground product is amorphous.

The ground product can have a surface area of about 20,000 cm²/g or more as determined in water by laser scattering analysis. Preferably, the ground product has a surface area of about 30,000 cm²/g or more, or about 40,000 cm²/g or more. Generally, the ground product has a surface area of about 100,000 cm²/g or less. In a preferred embodiment, the ground product has a surface area of from about 20,000 cm²/g to about 80,000 cm²/g, or from about 40,000 cm²/g to about 80,000 cm²/g.

In accordance with the invention, the mixture of calcium sulfate dihydrate, water, and additive is wet ground in a mill assembly. First, the calcium sulfate dihydrate, water and additives are combined in any order and then are pumped to the mill assembly. The mill assembly can be any suitable wet milling assembly. Typically, the mill assembly comprises a grinding chamber containing a mill shaft fitted with discs and spacers and a plurality of beads. The discs and spacers comprise any suitable material, for example, the discs and spacers comprise at least one of stainless steel, PREMALLOY®, nylon, ceramics, and polyurethane. The discs and spacers preferably comprise PREMALLOY®. The discs selected for use in the grinding chamber can have any suitable shape. Typically the discs are standard flat discs or pinned discs, in particular pinned discs that are designed to improve axial flow of media through the mill. The mill shaft and corresponding grinding chamber can be oriented horizontally or vertically. In preferred embodiments, the mill shaft is oriented horizontally. Typically the grinding chamber is jacketed such that it can be water cooled. Preferably the grinding chamber is water cooled to maintain a constant grinding temperature.

The mill assembly can comprise any suitable beads, for example, balls and/or spheres. The beads can comprise any suitable material, for example the beads can comprise one or more metals or one or more ceramics. Suitable metals include stainless steel, carbon steel, chrome alloy steel, and the like. Suitable ceramic materials include zirconia, alumina, ceria, silica, glasses, and the like. As shown from lab testing, the sulfate groups of the calcium sulfate dihydrate produce a corrosive environment within the mill. Accordingly, it is preferable to use beads that are resistant to corrosion. Corrosion resistant beads include stainless steel beads or steel beads that are coated with corrosion resistant materials and ceramic beads. In a particularly preferred embodiment, the beads comprise ceria-stabilized zirconia comprising 20% ceria and 80% zirconia, for example ZIRCONOX® beads commercially available from Jyoti Ceramic Inds., Nashik, India.

The beads used in connection with the mill assembly can have any suitable size and density. Typically the size and density of the bead will determine, at least in part, the size of the calcium sulfate dihydrate particles and accordingly the viscosity of the wet gypsum accelerator that is produced by the milling process. In order to achieve a calcium sulfate dihydrate median particle size of from about 0.5 micron to about 2 microns, it is desirable to use beads having an average bead diameter of from about 0.5 mm to about 3 mm. Preferably, the beads have an average bead diameter of from about 1 mm to about 2 mm. Desirably the beads have a density of about 2.5 g/cm³ or greater. Preferably, the beads have a density of about 4 g/cm³ or greater. More preferably, the beads have a density of about 6 g/cm³ or greater. In a particularly preferred embodiment, the beads are ZIRCONOX® ceramic beads having a median particle size of from about 1.2 mm to about 1.7 mm and a density of about 6.1 g/cm³ or greater. Desirably the beads are present in the mill assembly in an amount of about 70 volume % or greater. Preferably about 70 volume % to about 90 volume % of the beads is present in the mill assembly. More preferably about 75 volume % to about 85 volume % of the beads is present in the mill assembly.

The wet gypsum accelerator of the invention can be produced in a batch operation or a continuous operation. In a typical wet gypsum accelerator production system for wallboard application, first calcium sulfate dihydrate, water, and the additives are mixed in a feed tank. In some embodiments, this mixing is conducted for about 8 minutes. The time of mixing will depend, in part, on the size of the batch and the feed rate. In some embodiments, it is desirable for the calcium sulfate dihydrate to be added to a mill assembly via an automatic feeding system. The resulting mixture is then conveyed to a water cooled mill assembly by a feed pump. The mixture is continuously ground and recirculated through a closed loop recirculation system for about 10 minutes or more. The actual grinding time will depend, at least in part, on the final median particle size desired for the calcium sulfate dihydrate particles and/or the viscosity desired for the wet gypsum accelerator slurry, as well as the size and density of the milling beads used to grind the calcium sulfate dihydrate particles. Typically, the mixture is ground for about 15 minutes to about 50 minutes. Preferably the mixture is ground for about 20 minutes to about 40 minutes. More preferably the mixture is ground for about 25 minutes to about 35 minutes. Once the desired median particle size is obtained, the mixture is allowed to exit the mill assembly. In some embodiments, a median particle size of from about 0.5 microns to about 2 microns is obtained. For a batch operation, the mixture is conveyed to a holding tank. When a batch operation is carried out, typically the mixture is ground in multiple passes via a closed loop system through the milling assembly. In some embodiments, about 4 to 5 passes are performed at a flow rate of about 10-15 gallons/min. In a continuous operation mode, the mixture is conveyed directly to the board mixer. When a continuous operation is carried out, typically the mixture is ground in single pass at a flow rate of from about 2 to 3 gallons per minute.

The wet gypsum accelerator of the invention desirably is added to an aqueous calcined gypsum mixture in an amount effective to accelerate and/or control the rate of conversion of the calcined gypsum mixture to set gypsum. Typically, the rate of hydration is evaluated on the basis of the “Time to 50% Hydration.” Time to 50% hydration can be shortened by using more accelerator. Gypsum accelerator provides nucleation sites so that more dihydrate crystals form and you get a larger number of thinner gypsum crystals. Other accelerators, such as potash and aluminum sulfate, make existing gypsum crystals grow faster, resulting in fewer, fatter crystals. A large number of thinner gypsum crystals make a stronger better matrix compared to fewer fatter gypsum crystals.

Because the hydration of calcined gypsum to set gypsum is an exothermic process, the Time to 50% Hydration can be calculated by determining the temperature increase caused by the hydration and then measuring the amount of time required to generate the temperature rise. The mid-point in time has been found to correspond to the Time to 50% Hydration, as is known to those skilled in the art. Preferably, the wet gypsum accelerator according to the invention results in Time to 50% Hydration of the calcined gypsum of about 8 minutes or less, more preferably 6 minutes or less. Even more preferably, use of wet gypsum accelerator according to the invention results in the Time to 50% Hydration of the calcined gypsum of about 5 minutes or less to about 4 minutes or less. The time to 50% hydration can be affected by a number of different factors such as the amount of accelerator used, the amount of calcium sulfate hemihydrate and water used, initial slurry temperature, and mixing energy used during the mixing. When measuring hydration, a control, can be run with fixed variables except for that variable being tested such as amount or type of WGA. This procedure allows for comparison of various types of accelerators in general as we as specific types of WGA.

The amount of wet gypsum accelerator added to an aqueous calcined gypsum mixture will depend on the components of the aqueous calcined gypsum mixture, such as the inclusion of set retarders, dispersants, foam, starch, paper fiber, and the like. By way of example, the inventive wet gypsum accelerator can be provided in an amount of from about 0.05% to about 3% by weight of the calcined gypsum, more preferably, in an amount of from about 0.5% to about 2% by weight of the calcined gypsum.

The calcined gypsum used to prepare the calcium sulfate dihydrate included in the wet gypsum accelerator of the invention can be in the form of calcium sulfate alpha hemihydrate, calcium sulfate beta hemihydrate, water-soluble calcium sulfate anhydrite, or mixtures of these various forms of calcium sulfate hemihydrates and anhydrites. The calcined gypsum can be fibrous or non-fibrous. Furthermore, the wet gypsum accelerator of the invention can be used to accelerate hydration of calcined gypsum of any of these forms of calcium sulfate hemihydrates and anhydrites as well as mixtures of the various forms of calcium sulfate hemihydrates and anhydrites such as fibrous and non-fibrous forms of calcined gypsum.

While not wishing to be bound by any particular theory, it is believed that, upon grinding, the desired additives according to the invention become associated with the freshly generated outer surface of the calcium sulfate dihydrate, providing at least a partial coating on the calcium sulfate dihydrate. Additives are believed to strongly and instantly adsorb on active sites of the fresh ground calcium sulfate dihydrate surface, where unwanted recrystallization could otherwise occur. As a result, by adsorbing on such active sites, the additives are believed to protect the size and shape of the active sites to prevent gypsum recrystallization of the ground gypsum upon exposure to water and heat and to protect the active sites of the ground gypsum during the wet grinding process itself.

The organic phosphonic compounds suitable for use in the wet gypsum accelerator of the invention at least one RPO₃M₂ functional group, where M is a cation, phosphorus, or hydrogen, and R is an organic group. Examples include organic phosphonates and phosphonic acids. Organic polyphosphonic compounds are preferred although organic monophosphonic compounds can be utilized as well according to the invention. The preferred organic polyphosphonic compounds include at least two phosphonate salt or ion groups, at least two phosphonic acid groups, or at least one phosphonate salt or ion group and at least one phosphonic acid group. A monophosphonic compound according to the invention includes one phosphonate salt or ion group or at least one phosphonic acid group.

The organic group of the organic phosphonic compounds is bonded directly to the phosphorus atom. The organic phosphonic compounds suitable for use in the invention include, but are not limited to, compounds characterized by the following structures: 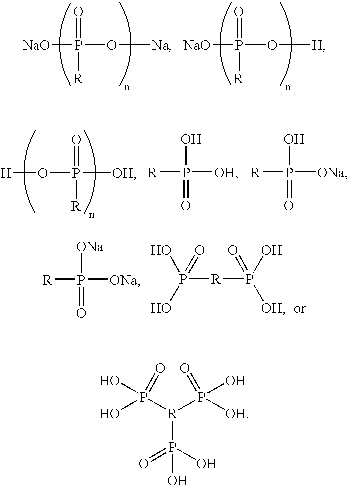
In these structures, R refers to an organic moiety containing at least one carbon atom bonded directly to a phosphorus atom P, and n is a number of from about 1 to about 1,000, preferably a number of from about 2 to about 50.

Organic phosphonic compounds include, for example, aminotri(methylenephosphonic acid), 1-hydroxyethylidene-1,1-diphosphonic acid, diethylenetriamine penta(methylenephosphonic acid), hexamethylenediamine tetra(methylenephosphonic acid), as well as any suitable salt thereof, such as, for example, a pentasodium salt, tetrasodium salt, trisodium salt, potassium salt, sodium salt, ammonium salt, calcium salt or magnesium salt of any of the foregoing acids, and the like, or combinations of the foregoing salts and/or acids. In some embodiments, DEQUEST® phosphonates commercially available from Solutia, Inc., St. Louis, Mo., are utilized in the invention. Examples of DEQUEST® phosphonates include DEQUEST® 2000, DEQUEST® 2006, DEQUEST® 2016, DEQUEST®2054, DEQUEST® 2060S, DEQUEST® 2066A, and the like. Other examples of suitable organic phosphonic compounds are found, for example, in U.S. Pat. No. 5,788,857.

Any suitable phosphate-containing compound providing a benefit of the invention can be utilized. By way of example, the phosphate-containing compound can be an orthophosphate or a polyphosphate, and furthermore, the phosphate-containing compound can be in the form of an ion, salt, or acid.

Suitable examples of phosphates according to the invention will be apparent to those skilled in the art. For example, any suitable orthophosphate-containing compound can be utilized in the practice of the invention, including, but not limited to, monobasic phosphate salts, such as monoammonium phosphate, monosodium phosphate, monopotassium phosphate, or combinations thereof. A preferred monobasic phosphate salt is monosodium phosphate. Polybasic orthophosphates also can be utilized in accordance with the invention.

Similarly, any suitable polyphosphate salt can be used in accordance with the present invention. The polyphosphate can be cyclic or acyclic. Examples of cyclic polyphosphates include trimetaphosphate salts, including double salts, that is, trimetaphosphate salts having two cations. The trimetaphosphate salt can be selected, for example, from sodium trimetaphosphate, potassium trimetaphosphate, calcium trimetaphosphate, sodium calcium trimetaphosphate, lithium trimetaphosphate, ammonium trimetaphosphate, aluminum trimetaphosphate, and the like, or combinations thereof. Sodium trimetaphosphate is a preferred trimetaphosphate salt. Also, any suitable acyclic polyphosphate salt can be utilized in accordance with the present invention. Preferably, the acyclic polyphosphate salt has at least two phosphate units. By way of example, suitable acyclic polyphosphate salts in accordance with the present invention include, but are not limited to, pyrophosphates, tripolyphosphates, sodium hexametaphosphate having from about 6 to about 27 repeating phosphate units, potassium hexametaphosphate having from about 6 to about 27 repeating phosphate units, ammonium hexametaphosphate having from about 6 to about 27 repeating phosphate units, and combinations thereof. A preferred acyclic polyphosphate salt pursuant to the present invention is commercially available as CALGON® from Solutia, Inc., St. Louis, Mo., which is a sodium hexametaphosphate having from about 6 to about 27 repeating phosphate units. In addition, the phosphate-containing compound can be in the acid form of any of the foregoing salts. The acid can be, for example, a phosphoric acid or polyphosphoric acid.

Preferably, the phosphate-containing compound is selected from the group consisting of tetrapotassium pyrophosphate, sodium acid pyrophosphate, sodium tripolyphosphate, tetrasodium pyrophosphate, sodium potassium tripolyphosphate, sodium hexametaphosphate salt having from 6 to about 27 phosphate units, ammonium polyphosphate, sodium trimetaphosphate, and combinations thereof.

The ingredients in the wet gypsum accelerator of the invention can be provided in any suitable amount. For example, the calcium sulfate dihydrate can be provided in an amount of at least about 20% by weight of the accelerator, preferably, at least about 30% by weight of the accelerator. The calcium sulfate dihydrate can be present, for example, in an amount of from about 35% to about 45% by weight of the accelerator, more preferably, in an amount of from about 38% to about 42% by weight of the accelerator. Generally, lower solids content provides higher efficiency but also significantly increases the grinding time resulting in a decrease in throughput and/or production rate.

The additive preferably is provided in as low of an amount as possible to minimize cost, while still achieving the desired benefits of enhancing longevity, such that the wet gypsum accelerator maintains its efficiency over time and withstands exposure to water and heat. Preferably, the additive component, whether a single additive or a combination of additives, is provided in an amount of from about 0.1% to about 10% by weight of the calcium sulfate dihydrate, more preferably, in an amount of from about 0.1% to about 2% by weight of the calcium sulfate dihydrate, and even more preferably, in an amount of from about 0.1% to about 1% by weight of the calcium sulfate dihydrate.

In preferred embodiments, at least one organic phosphonic compound is utilized as an additive. Organic phosphonic compounds generally are superior in enhancing the efficiency of the accelerator, even when included in relatively small amounts. More preferably, at least one phosphate-containing compound is used in combination with at least one organic phosphonic compound. For example, it is believed that, depending upon the size and shape of various active sites, the organic phosphonic compound can enhance nucleation at some active sites while the phosphate-containing compound can act at other sites such that the combination is desirable. Furthermore, in preferred embodiments, the phosphate containing compound, particularly cyclic compounds such as a trimetaphosphate compound, including at least one ion and/or salt, is added in conjunction with the organic phosphonic compound to enhance resistance to aging. It is believed that the inclusion of the phosphate-containing compound stabilizes and maintains the wet strength of the accelerator to improve aging properties of the wet gypsum accelerator.

In embodiments of the invention comprising more than one additive, each additive preferably is included in an amount suitable to achieve the longevity and/or the desired Time to 50% hydration, but preferably, the total amount of additive falls within the ranges described above. For example, in embodiments where at least one phosphate containing compound is used in combination with at least one organic phosphonic compound, the organic phosphonic compound preferably is included in an amount of from about 0.05% to about 9.95% by weight of the calcium sulfate dihydrate, and the phosphate-containing compound likewise preferably is present in an amount of from about 0.05% to about 9.95% by weight of the calcium sulfate dihydrate. In some embodiments, the additive is present at up to 10% by weight of the calcium sulfate dihydrate. In some embodiments, the additive is present from about 0.05% to about 4.95% by weight of the calcium sulfate dihyrdate. In a particularly preferred embodiment, the additive is a mixture of about 0.5% pentasodium salt of aminotri(methylenephosphonic acid) by weight of the calcium sulfate dihydrate and about 0.5% sodium trimetaphosphate by weight of the calcium sulfate dihydrate.

As an added benefit of the invention, the wet gypsum accelerator can be utilized as a means to provide organic phosphonic compound and/or inorganic phosphate compound as a pre-treatment to enhance various properties of the resulting set gypsum-containing composition and product, for example, wallboard, ceiling tiles, and the like, such as, for example, strength, dimensional stability, resistance to permanent deformation, and the like, as described in commonly assigned U.S. application Ser. No. 08/916,058 (abandoned) and commonly assigned U.S. Pat. Nos. 6,342,284, 6,409,824, and 6,632,550, hereby incorporated in their entireties by reference.

The following examples further illustrate the present invention but should not be construed as in any way limiting its scope.

### EXAMPLE 1

### Rate of Hydration

This Example illustrates the preparation of the wet gypsum accelerator and demonstrates the enhanced rate of hydration of calcined gypsum and efficiency resulting from the use of the wet gypsum accelerator of the invention as compared with dry gypsum accelerators.

To prepare each wet gypsum accelerator (WGA), a Premier HM-45 wet bead mill fitted with PREMALLOY® discs and spacers was used for initial wet grinding of calcium sulfate dihydrate from United States Gypsum Company's Galena Park plant in the presence of one or more additives. The calcium sulfate dihydrate starting material had an initial median particle size of about 55 microns. Specifically, 50 gallons of process water, 400 lbs of calcium sulfate dihydrate, and 0.5 wt. %, based on the weight of the calcium sulfate dihydrate, each of aminotri(methylenephosphonic acid), pentasodium salt (Dequest® 2006) and sodium trimetaphosphate (NaTMP) were combined and ground for 10 min, 20 min, and 25 min, respectively, at a flow rate of 13-15 gallons per minute, recirculation of 4-5 passes, in a spirally grooved stainless steel grinding chamber containing 75 to 82 volume % ZIRCONOX® ceramic beads having a diameter of 1.2 mm to 1.7 mm and a density of 6.1 g/cm³. The longer the grinding time for the WGA composition, the smaller the median particle size of the ground product. The resulting median particle size for each WGA composition is shown in Table 1.

Each of the WGA samples was then tested to determine the rate of hydration. For each test, 300 g of calcium sulfate hemihydrate from United States Gypsum Company's Southard plant was combined with 300 ml of tap water (70° F.). One gram dry weight basis of the WGA were added to the calcium sulfate hemihydrate slurry and the slurry was allowed to soak for 10 seconds followed by mixing for 7 seconds at low speed with a Waring blender. The resulting slurry was poured into a polystyrene foam cup, which was then placed into an insulated Styrofoam container to minimize heat loss to the environment during the hydration reaction. A temperature probe was placed into the middle of the slurry, and the temperature was recorded every 5 seconds. Since the setting reaction is exothermic, the extent of the reaction was measured by the temperature rise. The Time to 50% Hydration was determined to be the time to reach the temperature half-way between the minimum and maximum temperatures recorded during the test. The results are provided in Table 1.

TABLE 1
Wet Gypsum Accelerator Preparation and Evaluation

| WGA Preparation | | | | Bench Scale TRS Evaluation | | | |
|---|---|---|---|---|---|---|---|
| | | Median | Acceleration | Time to 50% | Time to 98% | | |
| | Grinding | particle size | Efficiency | Hydration | Hydration | Initial Slurry | Total Temp |
| # | Time (min) | (μm) | (%) | (min) | (min) | Temp (° F.) | Rise (° F.) |
| 1 | 10 | 2.2 ± 4.4 | 120 | 6.75 | 12.08 | 74.3 | 35.5 |
| 2 | 20 | 1.7 ± 3.4 | 180 | 5.83 | 11.33 | 72.0 | 35.9 |
| 3 | 25 | 1.4 ± 2.4 | 210 | 5.42 | 10.92 | 72.5 | 35.6 |

The results in Table 1 demonstrate that the time for 50% hydration decreases and the Acceleration Efficiency, shown as a percentage of Galena Park's normal dry heat-resistant accelerator's (HRA's) efficiency, increases as the median particle size of the calcium sulfate dihydrate decreases. Higher standard deviation of the median particle size means large particle size distribution (wide range), lower standard deviation of the median particle size means smaller particle size distribution (narrow range). Because the feed material is a narrow-ranged synthetic gypsum (˜50 micron), the median particle size of WGA product will normally have large particle size distribution with high standard deviation. Generally, the longer the grinding time is, the narrower the final particle size distribution with smaller standard deviation for the WGA product.

### EXAMPLE 2

### Rate of Hydration

This Example illustrates the preparation of the WGA and demonstrates the enhanced rate of hydration resulting from the use of the WGA of the invention.

To prepare each WGA, a Premier HML-1.5 wet bead mill (laboratory supermill) was used for initial wet grinding of eight different supplies of calcium sulfate dihydrate from United States Gypsum Company plants in the presence of one or more additives. The calcium sulfate dihydrate starting materials were of varying impurities ranging from high impurity mined gypsum to pure synthetic gypsum. Specifically, 4000 ml of tap water, 3000 grams of calcium sulfate dihydrate (43% solids), and 0.75 wt. %, based on the weight of the calcium sulfate dihydrate, each of aminotri(methylenephosphonic acid), pentasodium salt (Dequest® 2006) and sodium trimetaphosphate (NaTMP) were combined and ground at 0.6 gallons per minute, 4-5 passes, in a spirally grooved stainless steel grinding chamber containing 75 to 82 volume % ZIRCONOX® ceramic beads having a diameter of 1.2 mm to 1.7 mm and a density of 6.1 g/cm³. The relationship between the grinding time and viscosity is shown in Table 2 for each of the wet gypsum accelerator formulations.

TABLE 2
WGA Preparation and Evaluation

| # | Grinding Time (min) | WGA Viscosity (cP) |
|---|---|---|
| 1 | 10 | 1000 |
| | 15 | 2800 |
| | 20 | 4240 |
| 2 | 10 | 1000 |
| | 15 | 2100 |
| | 20 | 3480 |
| | 25 | 4600 |
| 3 | 10 | 1040 |
| | 15 | 2520 |
| | 20 | 4680 |
| 4 | 10 | 1200 |
| | 15 | 2560 |
| | 20 | 4960 |
| 5 | 10 | 1440 |
| | 20 | 5760 |
| 6 | 10 | 760 |
| | 15 | 2080 |
| | 20 | 3480 |
| | 25 | 5840 |
| 7 | 10 | 1240 |
| | 15 | 3680 |
| | 20 | 7360 |
| 8 | 10 | 3000 |
| | 15 | 5840 |
| | 20 | 10100 |

Each of the WGA formulations was then tested to determine the rate of hydration. For each test, 300 g of calcium sulfate hemihydrate from United States Gypsum Company's Southard plant was combined with 300 ml of tap water (70° F.). One gram dry weight basis of the WGA were added to the calcium sulfate hemihydrate slurry and the slurry was allowed to soak for 10 seconds followed by mixing for 7 seconds at low speed with a Waring blender. The resulting slurry was poured into a polystyrene foam cup, which was then placed into an insulated Styrofoam container to minimize heat loss to the environment during the hydration reaction. A temperature probe was placed into the middle of the slurry, and the temperature was recorded every 5 seconds. Since the setting reaction is exothermic, the extent of the reaction was measured by the temperature rise. The Time to 50% Hydration was determined to be the time to reach the temperature half-way between the minimum and maximum temperatures recorded during the test. The results are provided in Table 3.

TABLE 3
WGA Preparation and Evaluation

| WGA Preparation | | | Bench Scale TRS Evaluation | | | |
|---|---|---|---|---|---|---|
| | Grinding | WGA | Time to 50% | Time to 98% | | |
| | Time | Viscosity | Hydration | Hydration | Initial Slurry | Total Temp |
| # | (min) | (cP) | (min) | (min) | Temp (° F.) | Rise (° F.) |
| 1 | 20 | 4240 | 4.67 | 10.58 | 76.1 | 34.3 |
| 2 | 25 | 4600 | 4.83 | 10.75 | 75.0 | 35.4 |
| 3 | 20 | 4680 | 4.92 | 10.42 | 76.5 | 36.2 |
| 4 | 20 | 4960 | 4.75 | 10.25 | 76.4 | 36.1 |
| 5 | 20 | 5760 | 4.33 | 9.67 | 76.7 | 36.1 |
| 6 | 25 | 5840 | 4.42 | 10.17 | 74.7 | 34.4 |
| 7 | 20 | 7360 | 4.17 | 9.08 | 75.2 | 35.8 |
| 8 | 20 | 10100 | 4.25 | 9.92 | 74.5 | 37.8 |

The results in Tables 1-3 clearly demonstrate that the time for 50% and 98% hydration decreases as the viscosity increases and as the median particle size of ground product decreases. Generally, the longer the grinding time, the finer the median particle size of WGA ground product will be, the higher the viscosity of WGA will be, and the higher the acceleration efficiency will be.

### EXAMPLE 3

### Efficiency

This Example illustrates the preparation of the WGA and demonstrates the enhanced efficiency resulting from the use of the WGA of the invention.

To prepare each WGA, a Premier HML-1.5 wet bead mill (Laboratory Supermill) was used for initial wet grinding of calcium sulfate dihydrate from United States Gypsum Company's Southard plant in the presence of one or more additives. Specifically, three WGA formulations comprising (1) 43% solids, (2) 33% solids, and (3) 22% solids were tested. Formulation (1) comprised 4000 ml of tap water, 3000 grams of calcium sulfate dihydrate, and 0.75 wt. %, based on the weight of the calcium sulfate dihydrate, each of aminotri(methylenephosphonic acid), pentasodium salt (Dequest® 2006) and sodium trimetaphosphate (NaTMP). Formulation (2) comprised 4690 ml of tap water, 2310 grams of calcium sulfate dihydrate and 0.5 wt. %, based on the weight of the calcium sulfate dihydrate, each of aminotri(methylenephosphonic acid), pentasodium salt (Dequest® 2006) and sodium trimetaphosphate (NaTMP). Formulation (3) comprised 5460 ml of tap water, 1540 grams of calcium sulfate dihydrate, and 0.5 wt. %, based on the weight of the calcium sulfate dihydrate, each of aminotri(methylenephosphonic acid), pentasodium salt (Dequest® 2006) and sodium trimetaphosphate (NaTMP).

Each WGA formulation was combined and ground for specified time intervals, to take WGA samples for viscosity measurement and efficiency test, at 0.6 gallons per minute with 4-5 passes in a spirally grooved stainless steel grinding chamber containing 75 to 82 volume % ZIRCONOX® ceramic beads having a diameter of 1.2 mm to 1.7 mm and a density of 6.1 g/cm³. The relationship between the grinding time, the viscosity, time of hydration, and efficiency is shown in Table 4 for each of the WGA formulations.

TABLE 4
WGA Preparation and Evaluation

| WGA Preparation | | | Bench Scale TRS Evaluation | |
|---|---|---|---|---|
| | | WGA | Time to | |
| | Grinding | Viscosity | 50% Hydration | Efficiency |
| # | Time (min) | (Cp) | (min) | (%) |
| 1 | 10 | 1760 | 5.42 | 87 |
| (43% solids) | 15 | 4320 | 4.50 | 171 |
| 1 w/added | 15 | 2560 | 4.58 | 160 |
| dispersant | 20 | 4160 | 4.25 | 210 |
| | 25 | 10000 | 3.58 | 390 |
| 2 | 0 | 40 | 8.17 | 20 |
| (33% solids) | 10 | 560 | 5.17 | 103 |
| | 15 | 1280 | 4.58 | 160 |
| | 20 | 2720 | 4.25 | 210 |
| | 25 | 4320 | 3.92 | 281 |
| | 27 | 4880 | 3.75 | 330 |
| 3 | 10 | 120 | — | — |
| (22% solids) | 15 | 240 | — | — |
| | 20 | 400 | — | — |
| | 25 | 720 | 4.33 | 196 |
| | 30 | 920 | 4.00 | 261 |
| | 35 | 1200 | — | — |
| | 40 | 1560 | 3.58 | 390 |
| | 45 | 2000 | — | — |
| | 50 | 2480 | 3.42 | 460 |
| | 55 | 3040 | — | — |
| | 60 | 3400 | 3.25 | 553 |

The results in Table 4 demonstrate that WGA formulations in accordance with the invention having a low solids content can have exceptional efficiencies without sacrificing the workability of the slurry. However, the WGA production throughput is significantly decreased with low solids content. Therefore, a solid content of at least about 30% is desirable in order to optimize WGA's production rate, performance efficiency, and workability. In some embodiments, the solid content is from about 38% to about 42%.

All of the references cited herein, including patents, patent applications, and publications, are hereby incorporated in their entireties by reference.

While this invention has been described with an emphasis upon preferred embodiments, it will be apparent to those of ordinary skill in the art that variations of the preferred embodiments may be used and that it is intended that the invention may be practiced otherwise than as specifically described herein. Accordingly, this invention includes all modifications encompassed within the scope of the invention as defined by the following claims.

What is claimed is:

1. A wet gypsum accelerator comprising:
(a) ground product having a median particle size of from about 0.5 micron to about 2 microns, wherein the ground product comprises calcium sulfate dihydrate;
(b) water, and
(c) an additive selected from the group consisting of:
(i) an organic phosphonic compound;
(ii) a phosphate-containing compound; and
(iii) a mixture of (i) and (ii).

2. The wet gypsum accelerator of claim 1, wherein the ground product is substantially amorphous.

3. The wet gypsum accelerator of claim 1, wherein the ground product has a median particle size of from about 1 micron to about 1.7 microns.

4. The wet gypsum accelerator of claim 1, wherein the ground product has a median particle size of from about 1 micron to about 1.5 microns.

5. The wet gypsum accelerator of claim 1, wherein the additive is present in an amount of from about 0.1% to about 10% by weight of the calcium sulfate dihydrate.

6. The wet gypsum accelerator of claim 1, wherein the additive is a mixture of at least one organic phosphonic compound and at least one phosphate-containing compound, wherein the organic phosphonic compound is present in an amount of from about 0.05% to about 9.95% by weight of the calcium gypsum dihydrate, and wherein the phosphate-containing compound is present in an amount of from about 0.05% to about 9.95% by weight of the calcium gypsum dihydrate.

7. The wet gypsum accelerator of claim 1, wherein the additive is a mixture of about 0.5% pentasodium salt of aminotri(methylene phosphonic acid) by weight of the calcium gypsum dihydrate and about 0.5% sodium trimetaphosphate by weight of the calcium gypsum dihydrate.

8. The wet gypsum accelerator of claim 1, wherein the calcium sulfate dihydrate is present in an amount of at least about 20% by weight of said accelerator.

9. The wet gypsum accelerator of claim 1, wherein the calcium sulfate dihydrate is present in an amount of from about 35% to about 45% by weight of said accelerator.

10. The wet gypsum accelerator of claim 1, wherein the viscosity of the wet gypsum accelerator is from about 1000 cP to about 5000 cP.

11. The wet gypsum accelerator of claim 1, wherein the viscosity of the wet gypsum accelerator is from about 2000 cP to about 4000 cP.

12. The wet gypsum accelerator of claim 1, wherein said organic phosphonic compound is selected from the group consisting of aminotri(methylene-phosphonic acid), 1-hydroxyethylidene-1,1-diphosphonic acid, diethylenetriamine penta(methylene phosphonic acid), hexamethylene diamine tetra(methylene phosphonic acid), a pentasodium salt, trisodium salt, tetrasodium salt, sodium salt, ammonium salt, potassium salt, calcium salt, or magnesium salt of any of the foregoing acids, and combinations thereof.

13. The wet gypsum accelerator of claim 1, wherein the phosphate-containing compound is selected from the group consisting of orthophosphates, polyphosphates, and combinations thereof.

14. The wet gypsum accelerator of claim 11, wherein the phosphate-containing compound is selected from the group consisting of tetrapotassium pyrophosphate, sodium acid pyrophosphate, sodium tripolyphosphate, tetrasodium pyrophosphate, sodium potassium tripolyphosphate, sodium hexametaphosphate salt having from 6 to about 27 phosphate units, ammonium polyphosphate, sodium trimetaphosphate, and combinations thereof.

15. The wet gypsum accelerator of claim 1, wherein the accelerator, when added to a mixture comprising calcined gypsum and water used to form an interlocking matrix of set gypsum, allows for a Time to 50% Hydration of calcined gypsum of about 6 minutes or less.

16. The wet gypsum accelerator of claim 13, wherein the accelerator, when added to a mixture comprising calcined gypsum and water used to form an interlocking matrix of set gypsum, allows for a Time to 50% Hydration of calcined gypsum of about 5 minutes or less.

17. A method of preparing a wet gypsum accelerator comprising:
(a) wet grinding calcium sulfate dihydrate, water, and at least one additive selected from the group consisting of (i) an organic phosphonic compound; (ii) a phosphate-containing compound; and (iii) a mixture of (i) and (ii); and
(b) wet grinding the gypsum in the presence of the additive to form said wet gypsum accelerator so as to form a wet gypsum accelerator comprising ground product having a median particle size of from about 0.5 micron to about 2 microns.

18. The method of claim 17, further comprising:
providing a mill assembly comprising a mill shaft and beads, wherein the beads have an average bead diameter of from about 0.5 mm to about 3 mm and a density of about 2.5 g/cm³ or greater.

19. The method of claim 18, wherein the beads have an average bead diameter of from about 1 mm to about 2 mm.

20. The method of claim 18, wherein the beads are ceramic beads.

21. The method of claim 18, wherein the beads comprise ceria-stabilized zirconia.

22. The method of claim 18, wherein the calcium sulfate dihydrate is added to the mill assembly via an automatic feeding system.

23. The method of claim 18, wherein the wet grinding is carried out in a single pass through the bead mill assembly.

24. The method of claim 18, wherein the wet grinding is carried out in multiple passes through the bead mill assembly.

25. The method of claim 17, wherein the wet gypsum accelerator comprises ground product that is substantially amorphous.

26. The method of claim 17, wherein the wet gypsum accelerator comprises ground product having a median particle size of from about 1 micron to about 1.7 microns.

27. The method of claim 17, wherein the wet gypsum accelerator comprises ground product having a median particle size of from about 1 micron to about 1.5 microns.

28. The method of claim 17, wherein the calcium sulfate dihydrate is present in an amount of from about 35% to about 45% by weight of said accelerator.

29. The method of claim 17, wherein said organic polyphosphonic compound is selected from the group consisting of aminotri(methylene-phosphonic acid), 1-hydroxyethylidene-1,1-diphosphonic acid, diethylenetriamine penta(methylene phosphonic acid), hexamethylene diamine tetra(methylene phosphonic acid), a pentasodium salt, trisodium salt, tetrasodium salt, sodium salt, potassium salt, ammonium salt, calcium salt, or magnesium salt of any of the foregoing acids, and combinations thereof.

30. The method of claim 17, wherein the phosphate-containing compound is selected from the group consisting of orthophosphates, polyphosphates, and combinations thereof.

31. The method of claim 30, wherein the phosphate-containing compound is selected from the group consisting of tetrapotassium pyrophosphate, sodium acid pyrophosphate, sodium tripolyphosphate, tetrasodium pyrophosphate, sodium potassium tripolyphosphate, sodium hexametaphosphate salt having from 6 to about 27 phosphate units, ammonium polyphosphate, sodium trimetaphosphate sodium salt, ammonium salt, calcium salt, magnesium salt, or combinations thereof.

32. The method of claim 17, wherein the additive consists of a mixture of about 0.5% pentasodium salt of aminotri(methylene phosphonic acid), calcium sulfate dihydrate and about 0.5% sodium trimetaphosphate by weight of the calcium sulfate dihydrate.

33. A method of hydrating calcined gypsum to form an interlocking matrix of set gypsum comprising:
forming a mixture of calcined gypsum; water; and a wet gypsum accelerator, said wet gypsum accelerator comprising ground product having a median particle size of from about 0.5 micron to about 2 microns, wherein the ground product comprises calcium sulfate dihydrate, the accelerator further comprising water, and at least one additive selected from the group consisting of:
(i) an organic phosphonic compound;
(ii) a phosphate-containing compound; and
(iii) a mixture of (i) and (ii).

34. The method of claim 33, wherein the Time to 50% Hydration of the calcined gypsum is about 6 minutes or less.

35. The method of claim 33, wherein the Time to 50% Hydration of the calcined gypsum is about 5 minutes or less.

36. A set gypsum-containing composition comprising an interlocking matrix of the set gypsum formed from at least calcined gypsum, water, and an accelerator comprising calcium sulfate dihydrate having a median particle size of from about 0.5 micron to about 2 microns, water, and an additive selected from the group consisting of:
(i) an organic phosphonic compound;
(ii) a phosphate-containing compound; and
(iii) mixtures of (i) and (ii).

37. A set gypsum containing-product comprising the composition of claim 36.

38. The set gypsum containing-product of claim 36 wherein said product is a board or panel.
